(19) United States
(12) Patent Application Publication
(10) Pub. No.: US 2024/0039005 A1
(43) Pub. Date: Feb. 1, 2024

(54) HIGH ENERGY DENSITY ELECTROLYTE

(71) Applicant: ESS TECH, INC., Wilsonville, OR (US)

(72) Inventors: Neal Walters Kuperman, Portland, OR (US); Yang Song, West Linn, OR (US)

(21) Appl. No.: 18/360,693

(22) Filed: Jul. 27, 2023

Related U.S. Application Data
(60) Provisional application No. 63/369,728, filed on Jul. 28, 2022.

(51) Int. Cl. H01M 4/90; H01M 8/18

(52) U.S. Cl. CPC H01M 4/90; H01M 8/188

(57) ABSTRACT

Systems and methods are provided for an electrolyte for a flow battery comprising a redox active species and a plurality of supporting salts dissolved in the electrolyte. The redox active species having a concentration greater than 2.0 M and the plurality of dissolved supporting salts comprising a potassium salt, and ammonium salt, a calcium salt, and a manganese salt.

### CROSS REFERENCE TO RELATED APPLICATIONS

The present application claims priority to U.S. Provisional Application No. 63/369,728 entitled “HIGH ENERGY DENSITY ELECTROLYTE”, and filed Jul. 28, 2022. The entire contents of the above identified application is hereby incorporated by reference for all purposes.

### FIELD

The present description relates generally to electrolytes of a redox flow battery.

### BACKGROUND AND SUMMARY

Redox flow batteries are suitable for grid scale storage applications due to their capability for scaling power and capacity independently, as well as for charging and discharging over thousands of cycles with reduced performance losses in comparison to conventional battery technologies. Iron hybrid redox flow batteries are particularly attractive due to the incorporation of low cost materials in the cell stack. The iron redox flow battery (IFB) relies on iron, salt, and water for electrolyte. One way of increasing a capacity of the IFB without increasing the size of the IFB (e.g., the size of the electrolyte tanks) is to increase the concentration of iron salts dissolved in the electrolyte.

Attempts to increase the iron salt concentration in the electrolyte have been limited by the inherent solubility of the different salts included in the IFB electrolyte. As part of a conventional IFB electrolyte solution, iron salt may be used in the electrolyte at a concentration of 1.7 M. Alternatively, concentrations of iron salt as high as 5.5 M have been reported in the field of iron electrodeposition. However, the electrolytes used for iron electrodeposition, or any other electrolyte without sufficient electrochemically inactive supporting salts, may not be readily transferred to an IFB system without also resulting in an undesired decrease in columbic efficiency. Additionally, electrodeposition electrolytes may be formulated for use at high temperatures (e.g. above 60° C.) and are therefore not compatible with auxiliary components of plumbing used for the IFB.

The inventors have recognized the above mentioned drawbacks in the previous strategies for increasing an iron salt concentration in the electrolyte of the IFB and developed an electrolyte composition to at least partially overcome the drawbacks. In one example, an electrolyte for a redox flow battery may comprise a redox active species dissolved in the electrolyte and having a concentration of at least 2.0 M in addition to a plurality of dissolved supporting salts comprising a potassium salt, an ammonium salt, a calcium salt, and a manganese salt. The electrolyte composition may allow an increased capacity of the IFB without increasing a size of the electrolyte tanks or sacrificing battery stability. The electrolyte composition may be used with existing IFB components (e.g., cell stack, plumbing, pumps, etc.) allowing for an economical and efficient replacement of the conventional electrolyte with the electrolyte composition described herein. Further, the electrolyte may remain an aqueous electrolyte and the composition may maintain the low-cost, low-toxicity properties valued in IFB electrolytes.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic diagram of an example redox flow battery system including an electrolyte.

FIG. 2 shows a plot of percentage of theoretical discharge capacity as a function of a number of charging cycles of an IFB, comparing results from a reference electrolyte, a first high energy density electrolyte, and a second high energy density electrolyte.

FIG. 3 shows a plot of potential as a function of time for the reference electrolyte.

FIG. 4 shows a plot of potential as a function of time for the first high energy density electrolyte.

FIG. 5 shows a plot of potential as a function of time for the second high energy density electrolyte.

FIG. 6 shows a plot of efficiency as a function of number of charge cycles for the first high energy density electrolyte.

FIG. 7 shows a plot of efficiency as function of number of charge cycles for the second high energy density electrolyte.

FIG. 8 shows a plot of percentage of theoretical discharge capacity as a function of number of charge cycles in the IFB, comparing results for the first high energy density electrolyte to the second high energy density electrolyte.

FIG. 9 shows a plot comparing voltage profiles over time for the first high energy density electrolyte and the second high energy density electrolyte.

### DETAILED DESCRIPTION

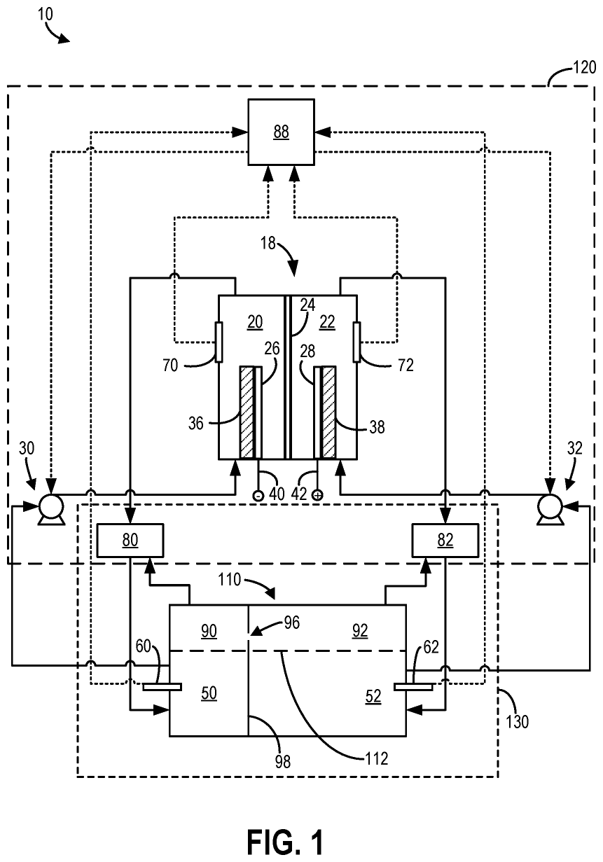

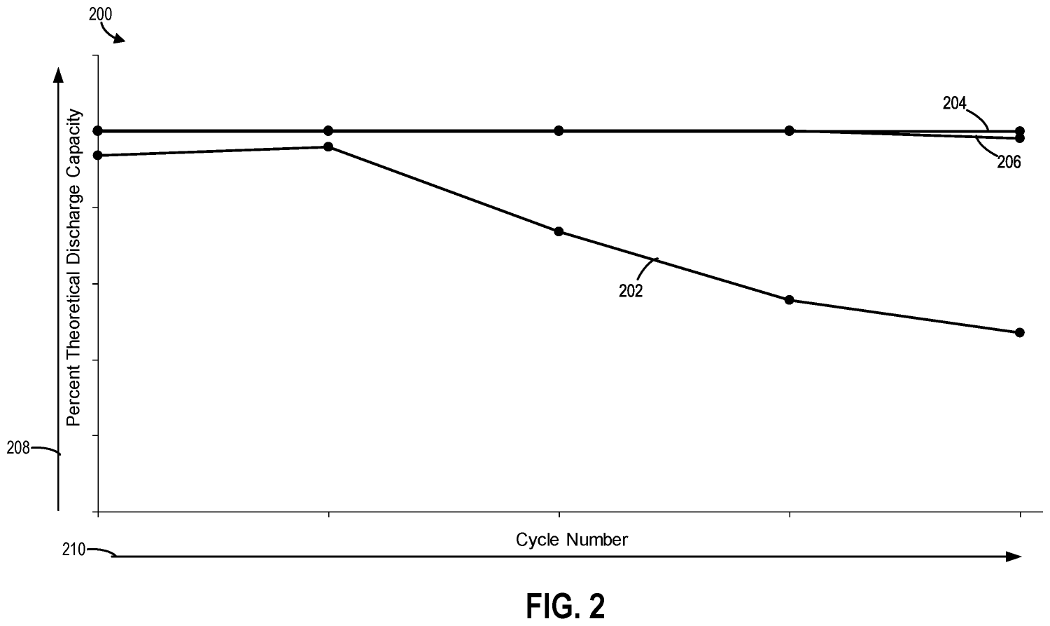

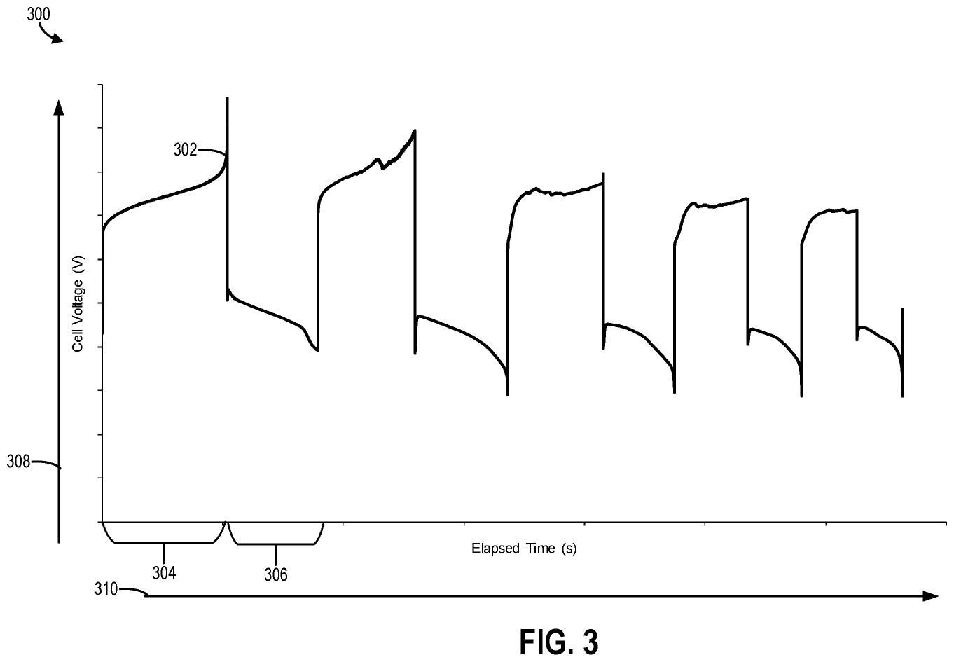

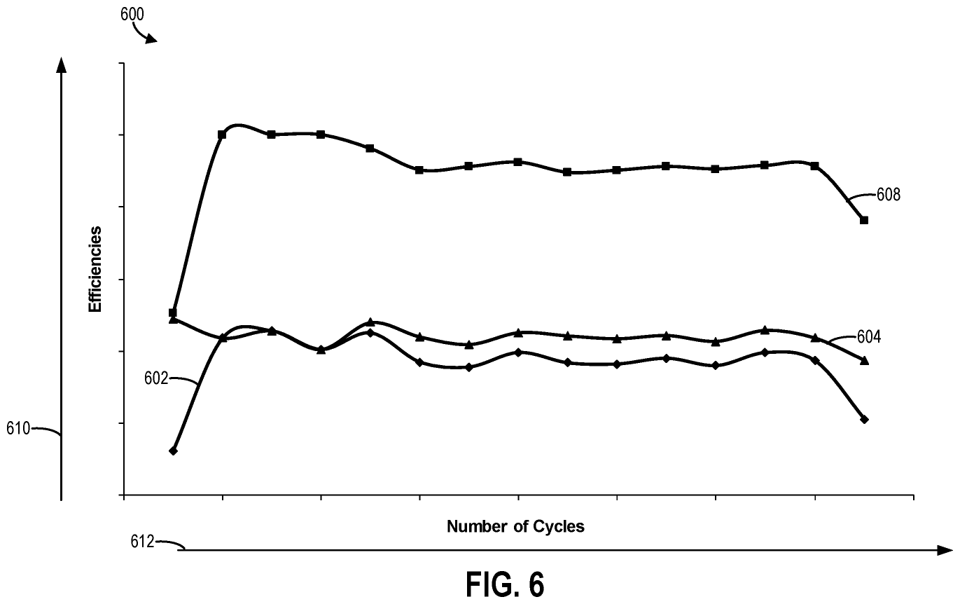

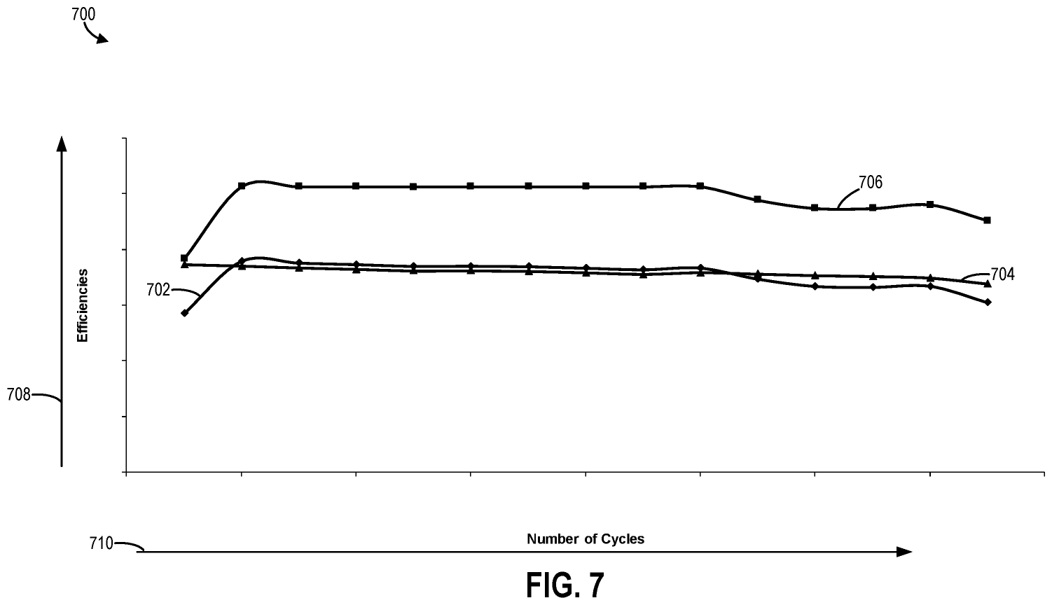

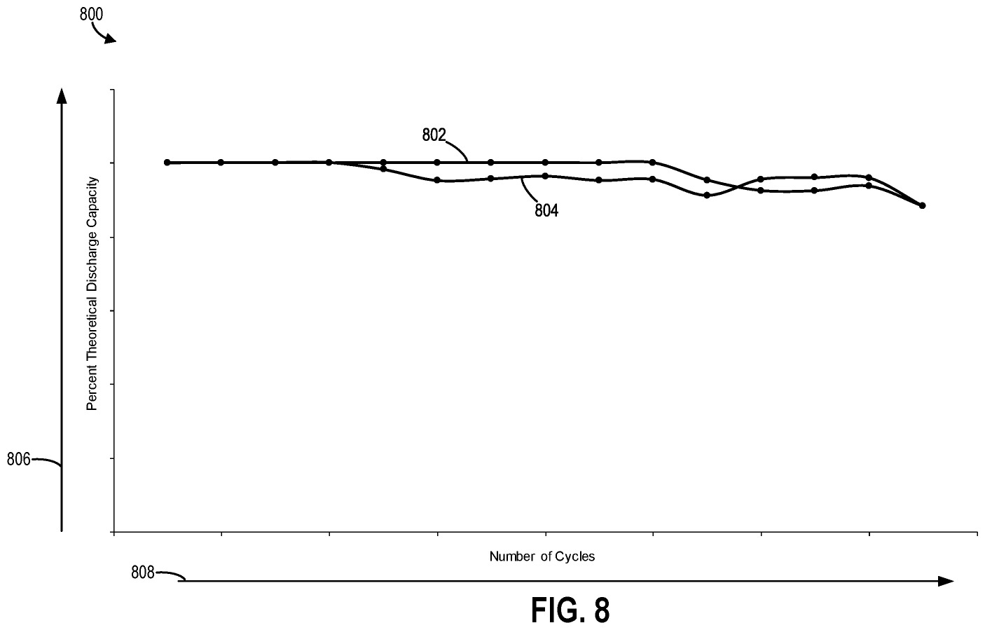

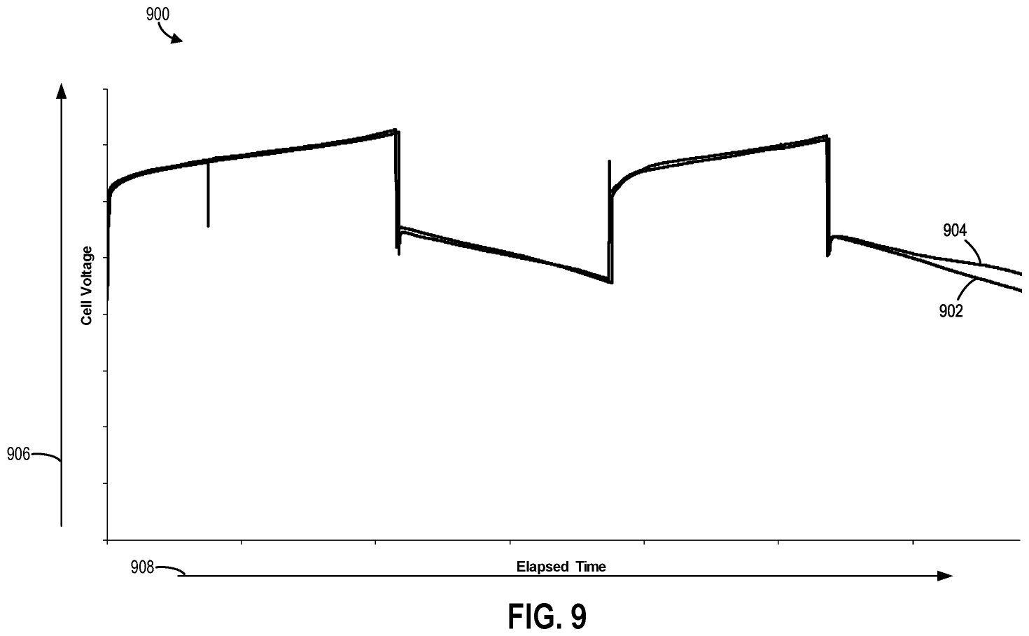

The following description relates to a composition of a high energy density electrolyte for an IFB. The electrolyte may be used in an IFB as depicted schematically in FIG. 1. The energy density of the IFB electrolyte may be increased by increasing a concentration of dissolved iron species in the electrolyte. The increased concentration of iron salts of the high energy density electrolyte described herein may be accomplished without sacrificing IFB performance by adjusting supporting salts in the electrolyte composition. Supporting salts may herein refer to salts included in an electrolyte for a redox flow battery which do not participate in redox reactions. For example, in a first example of the high energy density electrolyte, ammonium chloride may be added to a baseline electrolyte. In a second example of the high energy density electrolyte, ammonium chloride and calcium chloride may be added. The baseline electrolyte may include potassium chloride, manganese chloride and boric acid in addition to iron salt. FIG. 2 shows a plot comparing percentage of theoretical discharge capacity over numerous cycles for the IFB including the baseline electrolyte (as a reference electrolyte) as well as the first and second embodiments of the high energy density electrolyte. FIGS. 3-5 further compare the above listed electrolytes by showing plots of potential as a function of time for each of the electrolytes. FIGS. 6-7 further characterize the first and second examples of the high energy density electrolyte by showing plots comparing efficiency as a function of number of charge cycles for each of the electrolytes. Performances of the first embodiment of the high energy density electrolyte and the second embodiment of the high energy density electrolytes are highlighted in FIG. 8. For example, FIG. 8 further shows a plot of the data shown in FIG. 2, but without data from the baseline electrolyte. FIG. 9 plots an overlay of the voltaic profiles over time.

As shown in FIG. 1, in a redox flow battery system 10, a negative electrode 26 may be referred to as a plating electrode and a positive electrode 28 may be referred to as a redox electrode. A negative electrolyte within a plating side (e.g., a negative electrode compartment 20) of a redox flow battery cell 18 may be referred to as a plating electrolyte, and a positive electrolyte on a redox side (e.g., a positive electrode compartment 22) of the redox flow battery cell 18 may be referred to as a redox electrolyte.

“Anode” refers to an electrode where electroactive material loses electrons and “cathode” refers to an electrode where electroactive material gains electrons. During battery charge, the negative electrolyte gains electrons at the negative electrode 26, and the negative electrode 26 is the cathode of the electrochemical reaction. During battery discharge, the negative electrolyte loses electrons, and the negative electrode 26 is the anode of the electrochemical reaction. Alternatively, during battery discharge, the negative electrolyte and the negative electrode 26 may be respectively referred to as an anolyte and the anode of the electrochemical reaction, while the positive electrolyte and the positive electrode 28 may be respectively referred to as a catholyte and the cathode of the electrochemical reaction. During battery charge, the negative electrolyte and the negative electrode 26 may be respectively referred to as the catholyte and the cathode of the electrochemical reaction, while the positive electrolyte and the positive electrode 28 may be respectively referred to as the anolyte and the anode of the electrochemical reaction. For simplicity, the terms “positive” and “negative” are used herein to refer to the electrodes, electrolytes, and electrode compartments in redox flow battery systems.

One example of a hybrid redox flow battery is an all-iron redox flow battery (IFB), in which the electrolyte includes iron ions in the form of iron salts (e.g., FeCl₂, FeCl₃, and the like), wherein the negative electrode 26 includes metal iron. For example, at the negative electrode 26, ferrous iron (Fe²⁺) gains two electrons and plates as iron metal (Fe⁰) onto the negative electrode 26 during battery charge, and Fe⁺ loses two electrons and re-dissolves as Fe²⁺ during battery discharge. At the positive electrode 28, Fe²⁺ loses an electron to form ferric iron (Fe³⁺) during battery charge, and Fe³⁺ gains an electron to form Fe²⁺ during battery discharge. The electrochemical reaction is summarized in equations (1) and (2), wherein the forward reactions (left to right) indicate electrochemical reactions during battery charge, while the reverse reactions (right to left) indicate electrochemical reactions during battery discharge:

Fe²⁺+2e⁻↔Fe⁰−0.44 V (negative electrode) (1)

2Fe²⁺↔2Fe³⁺+2e⁻+0.77 V (positive electrode) (2)

As discussed above, the negative electrolyte used in the IFB may provide a sufficient amount of Fe²⁺ so that, during battery charge, Fe²⁺ may accept two electrons from the negative electrode 26 to form Fe⁰ and plate onto a substrate. During battery discharge, the plated Fe⁰ may lose two electrons, ionizing into Fe²⁺ and dissolving back into the electrolyte. An equilibrium potential of the above reaction is −0.44 V and this reaction therefore provides a negative terminal for the desired system. On the positive side of the IFB, the electrolyte may provide Fe²⁺ during battery charge which loses an electron and oxidizes to Fe³⁺. During battery discharge, Fe³⁺ provided by the electrolyte becomes Fe²⁺ by absorbing an electron provided by the positive electrode 28. An equilibrium potential of this reaction is +0.77 V, creating a positive terminal for the desired system.

The IFB may provide the ability to charge and recharge electrolytes therein in contrast to other battery types utilizing non-regenerating electrolytes. Charge may be achieved by respectively applying an electric current across the electrodes 26 and 28 via terminals 40 and 42. The negative electrode 26 may be electrically coupled via the terminal 40 to a negative side of a voltage source so that electrons may be delivered to the negative electrolyte via the positive electrode 28 (e.g., as Fe²⁺ is oxidized to Fe³⁺ in the positive electrolyte in the positive electrode compartment 22). The electrons provided to the negative electrode 26 may reduce the Fe²⁺ in the negative electrolyte to form Fe⁰ at the (plating) substrate, causing the Fe²⁺ to plate onto the negative electrode 26.

Discharge may be sustained while Fe⁰ remains available to the negative electrolyte for oxidation and while Fe³⁺ remains available in the positive electrolyte for reduction. As an example, Fe³⁺ availability may be maintained by increasing a concentration or a volume of the positive electrolyte in the positive electrode compartment 22 side of the redox flow battery cell 18 to provide additional Fe³⁺ ions via an external source, such as an external positive electrolyte chamber 52. More commonly, availability of Fe⁰ during discharge may be an issue in IFB systems, wherein the Fe⁰ available for discharge may be proportional to a surface area and a volume of the negative electrode substrate, as well as to a plating efficiency. Charge capacity may be dependent on the availability of Fe²⁺ in the negative electrode compartment 20. As an example, Fe²⁺ availability may be maintained by providing additional Fe²⁺ ions via an external source, such as an external negative electrolyte chamber 50 to increase a concentration or a volume of the negative electrolyte to the negative electrode compartment 20 side of the redox flow battery cell 18. It may be appreciated that increasing a concentration of iron in the positive and negative electrolytes may increase a capacity of the IFB system without increasing the volume of electrolyte. In this way, an energy density of the IFB system may be increased.

In an IFB, the positive electrolyte may include ferrous iron, ferric iron, ferric complexes, or any combination thereof, while the negative electrolyte may include ferrous iron or ferrous complexes, depending on a state of charge (SOC) of the IFB system. As previously mentioned, utilization of iron ions in both the negative electrolyte and the positive electrolyte may allow for utilization of the same electrolytic species on both sides of the redox flow battery cell 18, which may reduce electrolyte cross-contamination and may increase the efficiency of the IFB system, resulting in less electrolyte replacement as compared to other redox flow battery systems. Addition of supporting salts to the electrolytes as described below may allow for an increased iron concentration in the electrolyte solution. Supporting salts may be salts which increase a conductivity of the electrolyte solution and further aid in a stability of the redox active salts (e.g., FeCl₂) but are not oxidized or reduced during the operation of the redox flow battery.

Efficiency losses in an IFB may result from electrolyte crossover through a separator 24 (e.g., ion-exchange membrane barrier, microporous membrane, and the like). For example, Fe³⁺ ions in the positive electrolyte may be driven toward the negative electrolyte by a Fe³⁺ ion concentration gradient and an electrophoretic force across the separator 24. Subsequently, Fe³⁺ ions penetrating the separator 24 and crossing over to the negative electrode compartment 20 may result in coulombic efficiency losses. Fe³⁺ ions crossing over from the low pH redox side (e.g., more acidic positive electrode compartment 22) to the high pH plating side (e.g., less acidic negative electrode compartment 20) may result in precipitation of Fe(OH)₃. Precipitation of Fe(OH)₃ may degrade the separator 24 and cause permanent battery performance and efficiency losses. For example, Fe(OH)₃ precipitate may chemically foul an organic functional group of an ion-exchange membrane or physically clog micropores of the ion-exchange membrane. In either case, due to the Fe(OH)₃ precipitate, membrane ohmic resistance may rise over time and battery performance may degrade. Precipitate may be removed by washing the IFB with acid, but constant maintenance and downtime may be disadvantageous for commercial battery applications. Furthermore, washing may be dependent on regular preparation of electrolyte, contributing to additional processing costs and complexity. Alternatively, adding specific organic acids to the positive electrolyte and the negative electrolyte in response to electrolyte pH changes may mitigate precipitate formation during battery charge and discharge cycling without driving up overall costs. Additionally, implementing a membrane barrier that inhibits Fe²⁺ ion crossover may also mitigate fouling.

Additional coulombic efficiency losses may be caused by reduction of H⁺ (e.g., protons) and subsequent formation of H₂ gas, and a reaction of protons in the negative electrode compartment 20 with electrons supplied at the plated iron metal of the negative electrode 26 to form H₂ gas.

The IFB electrolyte (e.g., FeCl₂, FeCl₃, FeSO₄, Fe₂(SO₄)₃, and the like) may be readily available and may be produced at low costs. In one example, the IFB electrolyte may be formed from ferrous chloride (FeCl₂), potassium chloride (KCl), manganese(II) chloride (MnCl₂), and boric acid (H₃BO₃). Additionally, ammonium chloride (NH₄Cl) and calcium chloride (CaCl₂) may be included in the electrolyte and may allow a concentration of Fe^{2+/3+} in solution to be increased past what is typically considered to be stable. In this way, a high energy density electrolyte may be formed. The IFB electrolyte may offer higher reclamation value because the same electrolyte may be used for the negative electrolyte and the positive electrolyte, consequently reducing cross-contamination issues as compared to other systems. Furthermore, because of iron's electron configuration, iron may solidify into a generally uniform solid structure during plating thereof on the negative electrode substrate. For zinc and other metals commonly used in hybrid redox batteries, solid dendritic structures may form during plating. A stable electrode morphology of the IFB system may increase the efficiency of the battery in comparison to other redox flow batteries. Further still, iron redox flow batteries may reduce the use of toxic raw materials and may operate at a relatively neutral pH as compared to other redox flow battery electrolytes. Accordingly, IFB systems may reduce environmental hazards as compared with all other current advanced redox flow battery systems in production.

Continuing with FIG. 1, a schematic illustration of the redox flow battery system 10 is shown. The redox flow battery system 10 may include the redox flow battery cell 18 fluidly coupled to an integrated multi-chambered electrolyte storage tank 110. The redox flow battery cell 18 may include the negative electrode compartment 20, separator 24, and positive electrode compartment 22. The separator 24 may include an electrically insulating ionic conducting barrier which prevents bulk mixing of the positive electrolyte and the negative electrolyte while allowing conductance of specific ions therethrough. For example, and as discussed above, the separator 24 may include an ion-exchange membrane and/or a microporous membrane.

The negative electrode compartment 20 may include the negative electrode 26, and the negative electrolyte may include electroactive materials. The positive electrode compartment 22 may include the positive electrode 28, and the positive electrolyte may include electroactive materials. In some examples, multiple redox flow battery cells 18 may be combined in series or in parallel to generate a higher voltage or electric current in the redox flow battery system 10.

Further illustrated in FIG. 1 are negative and positive electrolyte pumps 30 and 32, both used to pump electrolyte solution through the redox flow battery system 10. Electrolytes are stored in one or more tanks external to the cell, and are pumped via the negative and positive electrolyte pumps 30 and 32 through the negative electrode compartment 20 side and the positive electrode compartment 22 side of the redox flow battery cell 18, respectively.

The redox flow battery system 10 may also include a first bipolar plate 36 and a second bipolar plate 38, each positioned along a rear-facing side, e.g., opposite of a side facing the separator 24, of the negative electrode 26 and the positive electrode 28, respectively. The first bipolar plate 36 may be in contact with the negative electrode 26 and the second bipolar plate 38 may be in contact with the positive electrode 28. In other examples, however, the bipolar plates 36 and 38 may be arranged proximate but spaced away from the electrodes 26 and 28 and housed within the respective electrode compartments 20 and 22. In either case, the bipolar plates 36 and 38 may be electrically coupled to the terminals 40 and 42, respectively, either via direct contact therewith or through the negative and positive electrodes 26 and 28, respectively. The IFB electrolytes may be transported to reaction sites at the negative and positive electrodes 26 and 28 by the first and second bipolar plates 36 and 38, resulting from conductive properties of a material of the bipolar plates 36 and 38. Electrolyte flow may also be assisted by the negative and positive electrolyte pumps 30 and 32, facilitating forced convection through the redox flow battery cell 18. Reacted electrochemical species may also be directed away from the reaction sites by a combination of forced convection and a presence of the first and second bipolar plates 36 and 38.

As illustrated in FIG. 1, the redox flow battery cell 18 may further include the negative battery terminal 40 and the positive battery terminal 42. When a charge current is applied to the battery terminals 40 and 42, the positive electrolyte may be oxidized (loses one or more electrons) at the positive electrode 28, and the negative electrolyte may be reduced (gains one or more electrons) at the negative electrode 26. During battery discharge, reverse redox reactions may occur on the electrodes 26 and 28. In other words, the positive electrolyte may be reduced (gains one or more electrons) at the positive electrode 28, and the negative electrolyte may be oxidized (loses one or more electrons) at the negative electrode 26. An electrical potential difference across the battery may be maintained by the electrochemical redox reactions in the positive electrode compartment 22 and the negative electrode compartment 20, and may induce an electric current through a current collector while the reactions are sustained. An amount of energy stored by a redox battery may be limited by an amount of electroactive material available in electrolytes for discharge, depending on a total volume of electrolytes and a solubility of the electroactive materials.

The redox flow battery system 10 may further include the integrated multi-chambered electrolyte storage tank 110. The multi-chambered electrolyte storage tank 110 may be divided by a bulkhead 98. The bulkhead 98 may create multiple chambers within the multi-chambered electrolyte storage tank 110 so that both the positive and negative electrolytes may be included within a single tank. The negative electrolyte chamber 50 holds negative electrolyte including the electroactive materials, and the positive electrolyte chamber 52 holds positive electrolyte including the electroactive materials. The bulkhead 98 may be positioned within the multi-chambered electrolyte storage tank 110 to yield a desired volume ratio between the negative electrolyte chamber 50 and the positive electrolyte chamber 52. In one example, the bulkhead 98 may be positioned to set a volume ratio of the negative and positive electrolyte chambers 50 and 52 according to a stoichiometric ratio between the negative and positive redox reactions. FIG. 1 further illustrates a fill height 112 of the multi-chambered electrolyte storage tank 110, which may indicate a liquid level in each tank compartment. FIG. 1 also shows a gas head space 90 located above the fill height 112 of the negative electrolyte chamber 50, and a gas head space 92 located above the fill height 112 of the positive electrolyte chamber 52. The gas head space 92 may be utilized to store H₂ gas generated through operation of the redox flow battery (e.g., due to proton reduction and iron corrosion side reactions) and conveyed to the multi-chambered electrolyte storage tank 110 with returning electrolyte from the redox flow battery cell 18. The H₂ gas may be separated spontaneously at a gas-liquid interface (e.g., the fill height 112) within the multi-chambered electrolyte storage tank 110, thereby precluding having additional gas-liquid separators as part of the redox flow battery system 10. Once separated from the electrolyte, the H₂ gas may fill the gas head spaces 90 and 92. As such, the stored H₂ gas may aid in purging other gases from the multi-chambered electrolyte storage tank 110, thereby acting as an inert gas blanket for reducing oxidation of electrolyte species, which may help to reduce redox flow battery capacity losses. In this way, utilizing the integrated multi-chambered electrolyte storage tank 110 may forego having separate negative and positive electrolyte storage tanks, hydrogen storage tanks, and gas-liquid separators common to conventional redox flow battery systems, thereby simplifying a system design, reducing a physical footprint of the redox flow battery system 10, and reducing system costs.

FIG. 1 also shows a spillover hole 96, which may create an opening in the bulkhead 98 between the gas head spaces 90 and 92, and may provide a means of equalizing gas pressure between the chambers 50 and 52. The spillover hole 96 may be positioned at a threshold height above the fill height 112. The spillover hole 96 may further enable a capability to self-balance the electrolytes in each of the negative and positive electrolyte chambers 50 and 52 in the event of a battery crossover. In the case of an all-iron redox flow battery system, the same electrolyte (Fe²⁺) is used in both negative and positive electrode compartments 20 and 22, so spilling over of electrolyte between the negative and positive electrolyte chambers 50 and 52 may reduce overall system efficiency, but overall electrolyte composition, battery module performance, and battery module capacity may be maintained. Flange fittings may be utilized for all piping connections for inlets and outlets to and from the multi-chambered electrolyte storage tank 110 to maintain a continuously pressurized state without leaks. The multi-chambered electrolyte storage tank 110 may include at least one outlet from each of the negative and positive electrolyte chambers 50 and 52, and at least one inlet to each of the negative and positive electrolyte chambers 50 and 52. Furthermore, one or more outlet connections may be provided from the gas head spaces 90 and 92 for directing H₂ gas to rebalancing reactors or cells 80 and 82.

Although not shown in FIG. 1, the integrated multi-chambered electrolyte storage tank 110 may further include one or more heaters thermally coupled to each of the negative electrolyte chamber 50 and the positive electrolyte chamber 52. In alternate examples, only one of the negative and positive electrolyte chambers 50 and 52 may include one or more heaters. In the case where only the positive electrolyte chamber 52 includes one or more heaters, the negative electrolyte may be heated by transferring heat generated at the redox flow battery cell 18 to the negative electrolyte. In this way, the redox flow battery cell 18 may heat and facilitate temperature regulation of the negative electrolyte. The one or more heaters may be actuated by a controller 88 to regulate a temperature of the negative electrolyte chamber 50 and the positive electrolyte chamber 52 independently or together. For example, in response to an electrolyte temperature decreasing below a threshold temperature, the controller 88 may increase a power supplied to one or more heaters so that a heat flux to the electrolyte may be increased. The electrolyte temperature may be indicated by one or more temperature sensors mounted at the multi-chambered electrolyte storage tank 110, such as sensors 60 and 62. As examples, the one or more heaters may include coil type heaters or other immersion heaters immersed in the electrolyte fluid, or surface mantle type heaters that transfer heat conductively through the walls of the negative and positive electrolyte chambers 50 and 52 to heat the fluid therein. Other known types of tank heaters may be employed without departing from the scope of the present disclosure. Furthermore, the controller 88 may deactivate the one or more heaters in the negative and positive electrolyte chambers 50 and 52 in response to a liquid level decreasing below a solids fill threshold level. Said in another way, in some examples, the controller 88 may activate the one or more heaters in the negative and positive electrolyte chambers 50 and 52 only in response to a liquid level increasing above the solids fill threshold level. In this way, activating the one or more heaters without sufficient liquid in the negative and/or positive electrolyte chambers 50, 52 may be averted, thereby reducing a risk of overheating or burning out the heater(s).

Further still, one or more inlet connections may be provided to each of the negative and positive electrolyte chambers 50 and 52 from a field hydration system (not shown). In this way, the field hydration system may facilitate commissioning of the redox flow battery system 10, including installing, filling, and hydrating the redox flow battery system 10, at an end-use location. Furthermore, prior to commissioning the redox flow battery system 10 at the end-use location, the redox flow battery system 10 may be dry-assembled at a battery manufacturing facility different from the end-use location without filling and hydrating the redox flow battery system 10, before delivering the redox flow battery system 10 to the end-use location. In one example, the end-use location may correspond to a location where the redox flow battery system 10 is to be installed and utilized for on-site energy storage. Said another way, the redox flow battery system 10 may be designed such that, once installed and hydrated at the end-use location, a position of the redox flow battery system 10 may become fixed, and the redox flow battery system 10 may no longer be deemed a portable, dry system. Thus, from a perspective of an end-user, the dry, portable redox flow battery system 10 may be delivered on-site, after which the redox flow battery system 10 may be installed, hydrated, and commissioned. Prior to hydration, the redox flow battery system 10 may be referred to as a dry, portable system, the redox flow battery system 10 being free of or without water and wet electrolyte. Once hydrated, the redox flow battery system 10 may be referred to as a wet, non-portable system, the redox flow battery system 10 including wet electrolyte.

Further illustrated in FIG. 1, electrolyte solutions primarily stored in the multi-chambered electrolyte storage tank 110 may be pumped via the negative and positive electrolyte pumps 30 and 32 throughout the redox flow battery system 10. Electrolyte stored in the negative electrolyte chamber 50 may be pumped via the negative electrolyte pump 30 through the negative electrode compartment 20 side of the redox flow battery cell 18, and electrolyte stored in the positive electrolyte chamber 52 may be pumped via the positive electrolyte pump 32 through the positive electrode compartment 22 side of the redox flow battery cell 18.

The electrolyte rebalancing reactors 80 and 82 may be connected in line or in parallel with the recirculating flow paths of the electrolyte at the negative and positive sides of the redox flow battery cell 18, respectively, in the redox flow battery system 10. One or more rebalancing reactors may be connected in-line with the recirculating flow paths of the electrolyte at the negative and positive sides of the battery, and other rebalancing reactors may be connected in parallel, for redundancy (e.g., a rebalancing reactor may be serviced without disrupting battery and rebalancing operations) and for increased rebalancing capacity. In one example, the electrolyte rebalancing reactors 80 and 82 may be placed in a return flow path from the negative and positive electrode compartments 20 and 22 to the negative and positive electrolyte chambers 50 and 52, respectively.

The electrolyte rebalancing reactors 80 and 82 may serve to rebalance electrolyte charge imbalances in the redox flow battery system 10 occurring due to side reactions, ion crossover, and the like, as described herein. In one example, electrolyte rebalancing reactors 80 and 82 may include trickle bed reactors, where the H₂ gas and electrolyte may be contacted at catalyst surfaces in a packed bed for carrying out the electrolyte rebalancing reaction. In other examples, the rebalancing reactors 80 and 82 may include flow-through type reactors that are capable of contacting the H₂ gas and the electrolyte liquid and carrying out the electrolyte rebalancing reactions absent a packed catalyst bed.

During operation of the redox flow battery system 10, sensors and probes may monitor and control chemical properties of the electrolyte such as electrolyte pH, concentration, SOC, and the like. For example, as illustrated in FIG. 1, sensors 62 and 60 maybe be positioned to monitor positive electrolyte and negative electrolyte conditions at the positive electrolyte chamber 52 and the negative electrolyte chamber 50, respectively. In another example, sensors 62 and 60 may each include one or more electrolyte level sensors to indicate a level of electrolyte in the positive electrolyte chamber 52 and the negative electrolyte chamber 50, respectively. As another example, sensors 72 and 70, also illustrated in FIG. 1, may monitor positive electrolyte and negative electrolyte conditions at the positive electrode compartment 22 and the negative electrode compartment 20, respectively. The sensors 72 and 70 may be pH probes, optical probes, pressure sensors, voltage sensors, etc. It will be appreciated that sensors may be positioned at other locations throughout the redox flow battery system 10 to monitor electrolyte chemical properties and other properties.

For example, a sensor may be positioned in an external acid tank (not shown) to monitor acid volume or pH of the external acid tank, wherein acid from the external acid tank may be supplied via an external pump (not shown) to the redox flow battery system 10 in order to reduce precipitate formation in the electrolytes. Additional external tanks and sensors may be installed for supplying other additives to the redox flow battery system 10. For example, various sensors including, temperature, conductivity, and level sensors of a field hydration system may transmit signals to the controller 88. Furthermore, the controller 88 may send signals to actuators such as valves and pumps of the field hydration system during hydration of the redox flow battery system 10. Sensor information may be transmitted to the controller 88 which may in turn actuate the pumps 30 and 32 to control electrolyte flow through the redox flow battery cell 18, or to perform other control functions, as an example. In this manner, the controller 88 may be responsive to one or a combination of sensors and probes.

The redox flow battery system 10 may further include a source of H₂ gas. In one example, the source of H₂ gas may include a separate dedicated hydrogen gas storage tank. In the example of FIG. 1, H₂ gas may be stored in and supplied from the integrated multi-chambered electrolyte storage tank 110. The integrated multi-chambered electrolyte storage tank 110 may supply additional H₂ gas to the positive electrolyte chamber 52 and the negative electrolyte chamber 50. The integrated multi-chambered electrolyte storage tank 110 may alternately supply additional H₂ gas to an inlet of the electrolyte rebalancing reactors 80 and 82. As an example, a mass flow meter or other flow controlling device (which may be controlled by the controller 88) may regulate flow of the H₂ gas from the integrated multi-chambered electrolyte storage tank 110. The integrated multi-chambered electrolyte storage tank 110 may supplement the H₂ gas generated in the redox flow battery system 10. For example, when gas leaks are detected in the redox flow battery system 10 or when a reduction reaction rate is too low at low hydrogen partial pressure, the H₂ gas may be supplied from the integrated multi-chambered electrolyte storage tank 110 in order to rebalance the SOC of the electroactive materials in the positive electrolyte and the negative electrolyte. As an example, the controller 88 may supply the H₂ gas from the integrated multi-chambered electrolyte storage tank 110 in response to a measured change in pH or in response to a measured change in SOC of an electrolyte or an electroactive material.

For example, an increase in pH of the negative electrolyte chamber 50, or the negative electrode compartment 20, may indicate that H₂ gas is leaking from the redox flow battery system 10 and/or that the reaction rate is too slow with the available hydrogen partial pressure, and the controller 88, in response to the pH increase, may increase a supply of H₂ gas from the integrated multi-chambered electrolyte storage tank 110 to the redox flow battery system 10. As a further example, the controller 88 may supply H₂ gas from the integrated multi-chambered electrolyte storage tank 110 in response to a pH change, wherein the pH increases beyond a first threshold pH or decreases beyond a second threshold pH. In the case of an IFB, the controller 88 may supply additional H₂ gas to increase a rate of reduction of Fe³⁺ ions and a rate of production of protons, thereby reducing the pH of the positive electrolyte. Furthermore, the pH of the negative electrolyte may be lowered by hydrogen reduction of Fe³⁺ ions crossing over from the positive electrolyte to the negative electrolyte or by protons, generated at the positive side, crossing over to the negative electrolyte due to a proton concentration gradient and electrophoretic forces. In this manner, the pH of the negative electrolyte may be maintained within a stable region, while reducing the risk of precipitation of Fe³⁺ ions (crossing over from the positive electrode compartment 22) as Fe(OH)₃.

Other control schemes for controlling a supply rate of H₂ gas from the integrated multi-chambered electrolyte storage tank 110 responsive to a change in an electrolyte pH or to a change in an electrolyte SOC, detected by other sensors such as an oxygen-reduction potential (ORP) meter or an optical sensor, may be implemented. Further still, the change in pH or SOC triggering action of the controller 88 may be based on a rate of change or a change measured over a time period. The time period for the rate of change may be predetermined or adjusted based on time constants for the redox flow battery system 10. For example, the time period may be reduced if a recirculation rate is high, and local changes in concentration (e.g., due to side reactions or gas leaks) may quickly be measured since the time constants may be small.

The controller 88 may further execute control schemes based on an operating mode of the redox flow battery system 10. For example, the controller 88 may control charging and discharging of the redox flow battery cell 18 so as to cause iron preformation at the negative electrode 26 during system conditioning (where system conditioning may include an operating mode employed to optimize electrochemical performance of the redox flow battery system 10 outside of battery cycling). That is, during system conditioning, the controller 88 may adjust one or more operating conditions of the redox flow battery system 10 to plate iron metal on the negative electrode 26 to improve a battery charge capacity during subsequent battery cycling (thus, the iron metal may be preformed for battery cycling). The controller 88 may further execute electrolyte rebalancing as discussed above to rid the redox flow battery system 10 of excess hydrogen gas and reduce Fe³⁺ ion concentration. In this way, preforming iron at the negative electrode 26 and running electrolyte rebalancing during the system conditioning may increase an overall capacity of the redox flow battery cell 18 during battery cycling by mitigating iron plating loss. As used herein, battery cycling (also referred to as “charge cycling”) may include alternating between a charging mode and a discharging mode of the redox flow battery system 10.

It will be appreciated that all components apart from the sensors 60 and 62 and the integrated multi-chambered electrolyte storage tank 110 (and components included therein) may be considered as being included in a power module 120. As such, the redox flow battery system 10 may be described as including the power module 120 fluidly coupled to the integrated multi-chambered electrolyte storage tank 110 and communicably coupled to the sensors 60 and 62. In some examples, each of the power module 120 and the multi-chambered electrolyte storage tank 110 may be included in a single housing (not shown), such that the redox flow battery system 10 may be contained as a single unit in a single location. It will further be appreciated the positive electrolyte, the negative electrolyte, the sensors 60 and 62, the electrolyte rebalancing reactors 80 and 82, and the integrated multi-chambered electrolyte storage tank 110 (and components included therein) may be considered as being included in an electrolyte subsystem 130. As such, the electrolyte subsystem 130 may supply one or more electrolytes to the redox flow battery cell 18 (and components included therein).

A size (e.g., volume) of an integrated multi-chambered electrolyte storage tank (such as integrated multi-chambered electrolyte storage tank 110) may determine the capacity of a redox flow battery system. If the redox flow battery is an IFB, the capacity of the battery may be further determined by an amount of iron ions that may be stored in the electrolyte storage tank. Without increasing the size of the electrolyte storage tank, the capacity of the battery may be increased by increasing a concentration of iron salts in the electrolyte. By increasing the capacity without changing the size of the electrolyte storage tank, an overall energy density of the system may be increased. High energy density electrolytes, as described below, may allow for an iron ion concentration of up to 3M by addition of supporting salts such as ammonium salts and calcium salts. Conventionally, potassium chloride may be used as the supporting salt and increasing an iron salt concentration may demand a concomitant increase in potassium chloride concentration. However, potassium chloride may not remain fully soluble and/or stable when concentrations are increased along with increasing iron salt concentrations. Minimizing a potassium chloride while increasing a concentration of alternative supporting salts (e.g., ammonium chloride and calcium chloride) may allow for an increase in solubility of the iron salts while maintaining the supporting salts fully soluble in the electrolyte.

Referring now to FIG. 2, a plot 200 is shown where discharge capacity as a percent of theoretical discharge capacity is plotted as a function of cycle number for an IFB cycling between two different SOCs (e.g., 20% to 80%). An arrow 208 indicates a direction of increasing discharge capacity along the y-axis of plot 200 and an arrow 210 indicates a direction of increasing cycle number along the x-axis of plot 200. Trace 202 corresponds to an IFB configured with a reference electrolyte (e.g., baseline electrolyte). The reference electrolyte may have the same iron salt concentration as a high energy density electrolyte but may lack additional supporting salts such as ammonium salts or calcium salts. In this way, comparing an IFB configured with the reference electrolyte to an IFB with the high energy density electrolyte may highlight differences due to the addition of ammonium salts or calcium salts. Trace 204 corresponds to an IFB configured with a first high energy density electrolyte. Trace 206 corresponds to an IFB configured with a second high energy density electrolyte. Table 1 below shows a composition of the reference electrolyte with composition ranges that may be used in high energy density electrolytes, such as the first and second high energy density electrolytes.

TABLE 1
Concentrations of reference and high
energy density electrolytes

| | Reference | High Energy Density |
|---|---|---|
| Component | Concentration | Concentration Ranges |
| FeCl₂ | 2.5M | 1.7M-3.0M |
| KCl | 1.0M | 0.5M-1.5M |
| MnCl₂ | 0.1M | 0M-0.25M |
| H₃BO₃ | 0.1M | 0M-0.4M |
| NH₄Cl | 0M | 0.5M-2.5M |
| CaCl₂ | 0M | 0M-1.5M |

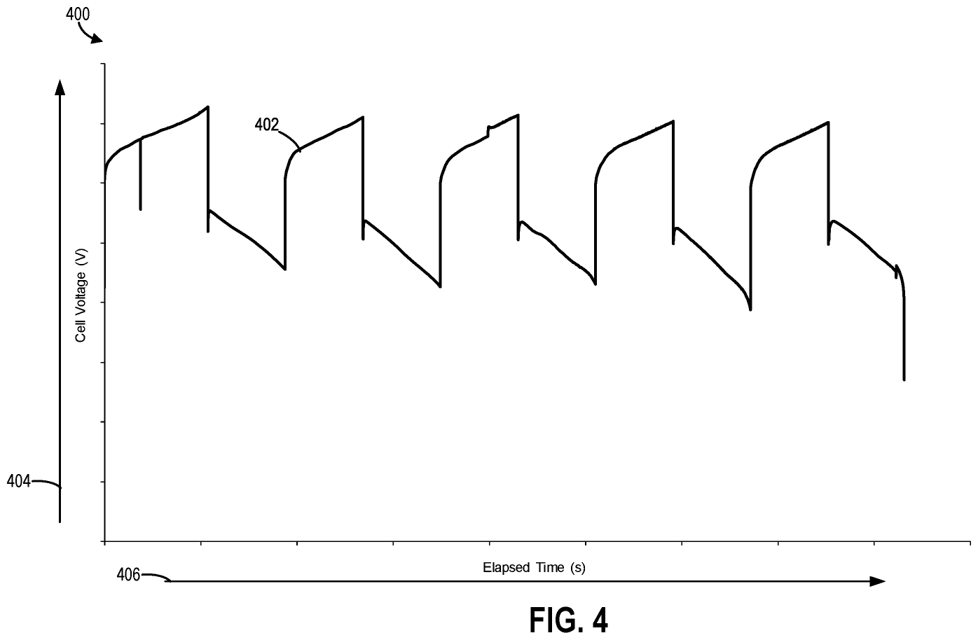

The high energy density electrolyte may include an iron salt such as FeCl 2 in a concentration range from 1.7 M up to 3.0 M. In one embodiment the iron salt concentration of the high energy density electrolyte may be at least 2.0 M. In addition to an increased concentration of iron salt, the high energy density may include ammonium chloride (NH₄Cl) and, optionally, calcium chloride (CaCl₂) to provide additional supporting salts. Potassium chloride (KCl) may be present at up to 1.5 M and may not be more than 1.5 M. Additionally, although the table above lists chloride salts, other anions (e.g., SO₄²⁻, and the like) have been considered within the scope of this application. The traces shown in FIG. 2, as well as those included in plots shown in FIGS. 4-10, may be collected from an IFB including either the first or the second high energy density electrolyte. The second high energy density electrolyte may differ from the first high energy density electrolyte by additional inclusion of calcium chloride. Table 2 below lists concentrations of the components of the first and second the high energy density electrolytes.

TABLE 2
Compositions of the first and second
high energy density electrolytes.

| | First High | Second High |
|---|---|---|
| | Energy Density | Energy Density |
| | Electrolyte | Electrolyte |
| Component | Concentrations | Concentrations |
| FeCl₂ | 2.5M | 2.5M |
| KCl | 1.0M | 1.0M |
| MnCl₂ | 0.1M | 0.1M |
| H₃BO₃ | 0.1M | 0.1M |
| NH₄Cl | 1.0M | 1.0M |
| CaCl₂ | 0M | 0.5M |

Trace 202 of FIG. 2 shows a decrease in discharge capacity of the IFB configured with the reference electrolyte after the second cycle. The discharge capacity continues to decrease over subsequent cycles, falling to discharging at 50% of a theoretical discharge capacity by the time 5 cycles are completed. In contrast, traces 204 and 206 show that when the IFB is configured with either the first or second high energy density electrolyte, the initial discharge capacity of the system is maintained at 100% of the theoretical discharge capacity over at least 5 cycles. Traces 202, 204, and 206 all correspond to systems using electrolytes with 2.5 M FeCl₂. It follows that the addition of ammonium chloride, and optionally calcium chloride, to the high energy density electrolytes aids in maintaining a discharge capacity of the IFB with a high iron salt concentration over multiple cycles. The discharge capacity of the IFB may be maintained because the electrolyte salts including both the iron salts and the potassium salts remain fully dissolved over at least 5 cycles.

Turning now to FIG. 3, plot 300 shows cell voltage (e.g., potential) as a function of time for the IFB configured with the reference electrolyte. An arrow 308 indicates a direction of increasing cell voltage along the y-axis of plot 300 and an arrow 310 indicates a direction of increasing elapsed time along the x-axis of plot 300. Over the course of the experiment (e.g., increasing time) the IFB may be continuously cycled from a 20% SOC to an 80% SOC multiple times. For example, the time period indicated by bracket 304 may correspond to the IFB system increasing from 20% SOC to 80% SOC and the time period indicated by bracket 306 may correspond to the IFB decreasing from 80% SOC to 20% SOC. Trace 302, may correspond to potential measured during charging/discharging of the IFB system and indicates unstable performance. Maximum charging cell voltage reached at 80% SOC may degrade over the course of multiple charging/discharging cycles which may indicate electrolyte degradation.

As discussed above with respect to FIG. 2, a discharge capacity of the IFB may decrease as the IFB system undergoes continued charging and discharging cycles when a concentration of the iron salt is increased past 2 M without addition of supporting salts such as ammonium chloride and calcium chloride. This may be evidenced by trace 302 showing an instability of measured cell potential over multiple charging/discharging events as described above. This may be due degradation of the electrolyte over time as a result of insolubility of iron at 2.5 M in the unsupported electrolyte.

Turning now to FIG. 4, plot 400 shows data plotted in a trace 402 collected in a manner similar to the data of FIG. 3 as discussed above but, with an IFB system incorporating the first high energy density electrolyte as discussed above with respect to Table 2. An arrow 404 indicates a direction of increasing cell voltage along the y-axis of plot 400 and arrow 406 indicates a direction of increasing elapsed time along the x-axis of plot 400. The first high energy density electrolyte may have a base composition similar to the composition of the reference electrolyte but additionally includes ammonium chloride at a concentration of 1 M (whereas the reference electrolyte does not include ammonium chloride). Addition of the ammonium chloride may increase the stability of iron chloride in the electrolyte. Trace 402 corresponds to measured cell voltage as a function of time over the course of charging and discharging. Unlike the data shown in FIG. 3, trace 402 shows a more stable performance of the IFB over multiple continuous charging/discharging cycles. Trace 402 indicates that the cell voltage repeatedly cycles between more consistent maximum and minimum cell voltages during the six charging/discharging cycles shown compared to the reference electrolyte. The data shown in FIG. 4 demonstrates resistance of the first high energy density electrolyte to degradation during battery operation and more stable battery performance despite comprising the same iron salt concentration as the reference electrolyte of the IFB measured in FIG. 3.

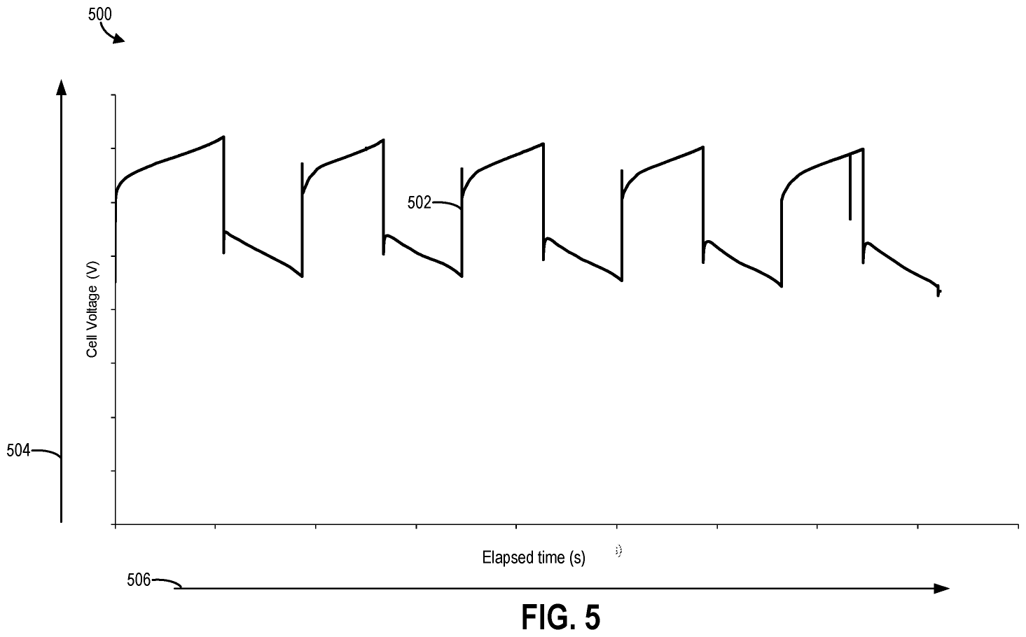

Turning now to FIG. 5, plot 500 shows data plotted in traces collected in a manner similar to the data of FIG. 3 and FIG. 4 as described above, but with an IFB system incorporating the second high energy density electrolyte, as discussed above with respect to Table 2. An arrow 504 indicates a direction of increasing cell voltage along the y-axis of plot 500 and an arrow 506 indicates a direction of increasing elapsed time along the x-axis of plot 500. The second high energy density electrolyte may be similar to the first high energy density electrolyte but may additionally include calcium chloride at a concentration of 0.5 M whereas the first high energy density electrolyte does not include calcium chloride. Trace 502 corresponds to measured cell potential as a function of time over the course of charging and discharging. Similar to the data shown in FIG. 4, trace 502 indicates a uniform and reproducible change between two potential values as the IFB charges and discharges over the time period in which data was collected, demonstrating more stable battery performance than achieved by the reference electrolyte.

FIG. 6 shows plot 600 depicting cycle efficiencies including: columbic efficiency, voltaic efficiency and energy efficiency as a function of number of charging/discharging cycles. An arrow 610 indicates a direction of increasing efficiency along the y-axis of plot 600 and an arrow 612 indicates a direction of increasing number of cycles along the x-axis of plot 600. Data shown in plot 600 may correspond to measurements collected using an IFB system incorporating the first high energy density electrolyte. Traces 602, 604, and 608 correspond to energy efficiency, voltaic efficiency, and coulombic efficiency respectively. Aside from changes between two early cycles and two of the last cycles, slopes of traces 602, 604, and 608 may be near zero. In other words, the efficiencies of the IFB including the first high energy capacity electrolyte may remain relatively uniform over a plurality of cycles without degradation of charge capacity.

Turning now to FIG. 7, plot 700 shows cycle efficiencies including: coulombic efficiency, voltaic efficiency, and energy efficiency as a function of number of charging/discharging cycles. An arrow 708 indicates a direction of increasing efficiency along the y-axis of plot 700 and an arrow 710 indicates a direction of increasing number of cycles along the x-axis of plot 700. The data shown in plot 700 may be analogous to the data shown in plot 600 of FIG. 6, but collected using an IFB system incorporating the second high energy density electrolyte. Traces 702, 704, and 706 correspond to energy efficiency, voltaic efficiency, and coulombic efficiency respectively. Similar to traces 602 and 604 and 608 of FIG. 6, traces 702, 704, and 706 remain relatively flat and indicates a stability of the electrolyte over a plurality of cycles. Further, traces 702, 704, and 706 may show a continued stability including up to a last cycle shown on plot 700 for the second high energy density electrolyte.

As described above with respect to FIGS. 2-7, both the first and second high energy density electrolytes may be more stable than the reference electrolyte over multiple charging/discharging cycles. While both the first and second high energy density electrolytes are relatively stable, especially compared to the reference electrolyte, there may also be a difference in stability between the first and second embodiments of the high energy density electrolytes which may be appreciated in FIGS. 8-9.

Turning now to FIG. 8, plot 800 shows percent of theoretical discharge capacity as a function of cycle number. An arrow 806 indicates a direction of increasing percent theoretical discharge capacity along the y-axis of plot 800 and arrow 808 shows a direction of increasing number of cycles along the x-axis of plot 800. Trace 804 corresponds to the first high energy density electrolyte and may be the same as trace 204 of FIG. 2. Trace 802 corresponds to the second high energy density electrolyte and may be the same as trace 206 of FIG. 2. However, traces 802 and 804 are plotted over 16 cycles in plot 800 as opposed to the 5 cycles plotted in plot 200. Trace 804 maintains a steady discharge capacity over 4 cycles, after which the discharge capacity fluctuates. Trace 802 maintains a steady discharge capacity over at least 10 cycles, after which the discharge capacity fluctuates. As evidenced in the comparison between traces 802 and 804, the calcium chloride included in the second embodiment of the high energy density electrolyte may maintain the discharge capacity of the IFB for a greater number of cycles.

Turning now to FIG. 9, plot 900 shows potential as a function of time. An arrow 906 indicates a direction of increasing cell voltage along the y-axis of plot 900 and an arrow 908 indicates a direction of increasing elapsed time along the x-axis of plot 900. Trace 902 corresponds to the first high energy density electrolyte and may be the same as trace 402 of FIG. 4. Trace 904 corresponds to the second the high energy density electrolyte and may be the same as trace 502 of FIG. 5. Trace 902 and trace 904 may be substantially the same, indicating that addition of calcium chloride to the high energy density electrolyte may have little effect on the potential of the IFB at low charging densities.

In this way, high energy density electrolytes having an iron concentration of up to 3 M in addition to supporting salts including calcium salts and ammonium salts may increase a capacity of the IFB system without demanding an increase in electrolyte volume. A footprint of the IFB system may remain compact as a result. The addition of supplementary supporting salts such as calcium salts and ammonium salts allow for the increase in the total iron concentration of the IFB electrolyte without negatively impacting the battery performance. The ammonium and/or calcium salts may maintain the desirable low-cost and low-toxicity features of the IFB electrolyte. Further, the ammonium and calcium salts may be added to both the negative electrolyte in negative electrode compartment of the IFB and a positive electrolyte in a positive electrode compartment of the IFB, with the negative electrolyte adjusted to have a lower pH than the positive electrolyte. Maintaining a shared composition of the two electrolytes may minimize the effects of ion cross-over.

The disclosure also provides support for an electrolyte for a redox flow battery, comprising: a redox active species dissolved in the electrolyte and having a concentration of greater than 2.0 M, and a plurality of dissolved supporting salts comprising a potassium salt, an ammonium salt, a calcium salt, and a manganese salt. In a first example of the system, the redox active species is an iron salt. In a second example of the system, optionally including the first example, the redox active species has a concentration range of 2.0 M up to 3.0 M. In a third example of the system, optionally including one or both of the first and second examples, the potassium salt is potassium chloride having a concentration range of 0.5 M up to 1.5 M. In a fourth example of the system, optionally including one or more or each of the first through third examples, the ammonium salt is ammonium chloride having a concentration range of 0.5 M up to 2.5 M. In a fifth example of the system, optionally including one or more or each of the first through fourth examples, the calcium salt is calcium chloride having a concentration range of 0 M up to 1.5 M. In a sixth example of the system, optionally including one or more or each of the first through fifth examples, the manganese salt is manganese chloride having a concentration range of 0 M up to 0.25 M. In a seventh example of the system, optionally including one or more or each of the first through sixth examples, the system further comprises: boric acid having a concentration range of 0 M up to 0.25 M. In a eighth example of the system, optionally including one or more or each of the first through seventh examples, the electrolyte is an aqueous electrolyte.

The disclosure also provides support for a redox flow battery, comprising: an electrolyte solution, wherein a composition of the electrolyte solution is shared between electrolyte in a negative electrode compartment and electrolyte a positive electrode compartment, the electrolyte solution comprising dissolved iron at a concentration of at least 2.0 M and dissolved supporting salts comprising an ammonium salt. In a first example of the system, the electrolyte solution in the negative electrode compartment has a lower pH than the electrolyte solution in the positive electrode compartment, and wherein the dissolved iron and the dissolved supporting salts remain fully dissolved in both the negative electrode compartment and the positive electrode compartment. In a second example of the system, optionally including the first example, the dissolved supporting salts further comprise a calcium salt and a discharge capacity of the redox flow battery is more uniform over a plurality of cycles when the dissolved supporting salts comprises the calcium salt than when the solution does not comprise the calcium salt. In a third example of the system, optionally including one or both of the first and second examples, the dissolved supporting salts further comprise a calcium salt and a discharge capacity of the redox flow battery is more uniform across a plurality of cycles when the dissolved supporting salts comprise the calcium salt and the ammonium salt than when the dissolved supporting salts do not comprise the calcium salt or the ammonium salt. In a fourth example of the system, optionally including one or more or each of the first through third examples, the dissolved supporting salts further comprise a calcium salt and a discharge capacity of the redox flow battery remains stable over at least 10 cycles. In a fifth example of the system, optionally including one or more or each of the first through fourth examples, the dissolved supporting salts further comprise potassium chloride and manganese chloride.

The disclosure also provides support for a electrolyte composition for a redox flow battery, comprising: an iron salt having a concentration of at least 2.0 M, an ammonium salt having a concentration of 0.5 M up to 2.5 M, and additional supporting salts at concentrations of 2.5 M or less. In a first example of the system, the iron salt participates in redox reactions during operation of the redox flow battery, and wherein the ammonium salt and the additional supporting salts do not participate in redox reactions during operation of the redox flow battery. In a second example of the system, optionally including the first example, a maximum charging cell voltage of the redox flow battery decreases with continued cycling when the ammonium salt is absent from the electrolyte composition. In a third example of the system, optionally including one or both of the first and second examples, the additional supporting salts comprises a calcium salt at a concentration of up to 1.5 M. In a fourth example of the system, optionally including one or more or each of the first through third examples, the redox flow battery is an iron redox flow battery.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An electrolyte for a redox flow battery, comprising:
a redox active species dissolved in the electrolyte and having a concentration of greater than 2.0 M; and
a plurality of dissolved supporting salts comprising a potassium salt, an ammonium salt, a calcium salt, and a manganese salt.

2. The electrolyte of claim 1, wherein the redox active species is an iron salt.

3. The electrolyte of claim 1, wherein the redox active species has a concentration range of 2.0 M up to 3.0 M.

4. The electrolyte of claim 1, wherein the potassium salt is potassium chloride having a concentration range of 0.5 M up to 1.5 M.

5. The electrolyte of claim 1, wherein the ammonium salt is ammonium chloride having a concentration range of 0.5 M up to 2.5 M.

6. The electrolyte of claim 1, wherein the calcium salt is calcium chloride having a concentration range of 0 M up to 1.5 M.

7. The electrolyte of claim 1, wherein the manganese salt is manganese chloride having a concentration range of 0 M up to 0.25 M.

8. The electrolyte of claim 1, further comprising boric acid having a concentration range of 0 M up to 0.25 M.

9. The electrolyte of claim 1, wherein the electrolyte is an aqueous electrolyte.

10. A redox flow battery, comprising:
an electrolyte solution, wherein a composition of the electrolyte solution is shared between electrolyte in a negative electrode compartment and electrolyte a positive electrode compartment, the electrolyte solution comprising dissolved iron at a concentration of at least 2.0 M and dissolved supporting salts comprising an ammonium salt.

11. The redox flow battery of claim 10, wherein the electrolyte solution in the negative electrode compartment has a lower pH than the electrolyte solution in the positive electrode compartment, and wherein the dissolved iron and the dissolved supporting salts remain fully dissolved in both the negative electrode compartment and the positive electrode compartment.

12. The redox flow battery of claim 10, wherein the dissolved supporting salts further comprise a calcium salt and a discharge capacity of the redox flow battery is more uniform over a plurality of cycles when the dissolved supporting salts comprises the calcium salt than when the solution does not comprise the calcium salt.

13. The redox flow battery of claim 10, wherein the dissolved supporting salts further comprise a calcium salt and a discharge capacity of the redox flow battery is more uniform across a plurality of cycles when the dissolved supporting salts comprise the calcium salt and the ammonium salt than when the dissolved supporting salts do not comprise the calcium salt or the ammonium salt.

14. The redox flow battery of claim 10, wherein the dissolved supporting salts further comprise a calcium salt and a discharge capacity of the redox flow battery remains stable over at least 10 cycles.

15. The redox flow battery of claim 10, wherein the dissolved supporting salts further comprise potassium chloride and manganese chloride.

16. A electrolyte composition for a redox flow battery, comprising:
an iron salt having a concentration of at least 2.0 M;
an ammonium salt having a concentration of 0.5 M up to 2.5 M; and
additional supporting salts at concentrations of 2.5 M or less.

17. The electrolyte composition of claim 16, wherein the iron salt participates in redox reactions during operation of the redox flow battery, and wherein the ammonium salt and the additional supporting salts do not participate in redox reactions during operation of the redox flow battery.

18. The electrolyte composition of claim 16, wherein a maximum charging cell voltage of the redox flow battery decreases with continued cycling when the ammonium salt is absent from the electrolyte composition.

19. The electrolyte composition of claim 16, wherein the additional supporting salts comprises a calcium salt at a concentration of up to 1.5 M.

20. The electrolyte composition of claim 16, wherein the redox flow battery is an iron redox flow battery.
